(19) United States
(12) Patent Application Publication
(10) Pub. No.: US 2004/0168455 A1
(43) Pub. Date: Sep. 2, 2004

(54) Vehicle air conditioner with regenerative electric power

(76) Inventor: Hiroki Nakamura, Chiryu-city (JP)

Correspondence Address: HARNESS, DICKEY & PIERCE, P.L.C., P.O. BOX 828, BLOOMFIELD HILLS, MI, 48303, US

(21) Appl. No.: 10/698,718

(22) Filed: Oct. 31, 2003

(30) Foreign Application Priority Data
Nov. 5, 2002 (JP) 2002-321269

(51) Int. Cl. B60H 1/32; F25B 27/00

(52) U.S. Cl. 62/244; 62/236; 62/134; 62/323.3

(57) ABSTRACT

In a vehicle air conditioner, it is determined whether a regenerative electric power generation is performed in an electric motor or not. When it is determined that the electric motor is in an electric power generating state, the electric supply to the electric heater is allowed. Accordingly, the allowed maximum electric-power value of a power consumption amount in the air conditioner becomes greater than the allowed maximum electric-power value set when it is determined that no electric motor is in the electric power generating state. Accordingly, it is possible to restrict an air conditioning feeling from becoming worse while preventing the electric power supplied to the electric motor from being insufficient due to consumption of the electric power of the battery by the air conditioner.

### CROSS REFERENCE TO RELATED APPLICATION

This application is based on Japanese Patent Application No. 2002-321269 filed on Nov. 5, 2002, the disclosure of which is incorporated herein by reference.

### FIELD OF THE INVENTION

The present invention relates to an air conditioner used for a vehicle having a regenerative electric-power generating unit for regenerating kinetic energy accumulated in the vehicle as electric energy by operating a driving source. The present invention is effectively applied to an air conditioner for a hybrid vehicle having an internal combustion engine and an electric motor for running.

### BACKGROUND OF THE INVENTION

In a conventional air conditioner for a vehicle, a heating of a passenger compartment is performed by heating air blown into a passenger compartment, using engine cooling water, i.e., waste heat of the engine as a heat source. However, when the temperature of the engine cooling water is low just after the engine is started, etc. and air blown into the passenger compartment cannot be sufficiently heated, the air blown into the passenger compartment is heated by an electric heater (e.g., see JP-A-2001-97028).

In an electric vehicle having an electric motor for running, such as a hybrid vehicle, etc., a large amount of electric power is consumed in the motor for running, and it is necessary to preferentially supply the electric power accumulated in a battery to the motor for running.

In contrast to this, a large amount of electric power is also required when the air blown into the passenger compartment is heated by the electric heater. Accordingly, when electricity is simply turned on in the electric heater, there is a fear that the electric power to be supplied to the motor for running is insufficient.

In the hybrid vehicle of the present situation, electricity is generated by operating an electric generator by the engine. Therefore, while the operation of the engine is stopped, the electric supply to electric parts no directly relating with the vehicle running is stopped since electric power consumption of the electric heater is large. Further, in the hybrid vehicle of the present situation, the operation of the engine is repeatedly stopped and started even during the vehicle running. Therefore, the electric supply and stoppage of the electric heater are repeated in response to this repetition. However, when the electric supply and stoppage of the electric heater are repeated, the temperature of the blown-out air is changed. Therefore, an air conditioning feeling becomes worse and the durability (life) of electric parts such as the electric heater, etc. is reduced.

### SUMMARY OF THE INVENTION

In view of the above problems, an object of the present invention is to restrict the air conditioning feeling from becoming worse while the generation of electric power insufficiency is prevented.

According to the present invention, an air conditioner is used for a vehicle having a regenerative electric-power generating unit for regenerating kinetic energy accumulated in the vehicle as electric energy by operating a driving source. The air conditioner includes an air conditioning unit having an electric part that is operated by electrical power, a regeneration determining means for determining whether the regenerative electric-power generating unit is in an electric-power generating state, and a control means for controlling an allowed maximum electric-power value to be consumed in the electric part. In the air conditioner, when the regeneration determination means determines that the regenerative electric-power generating unit is in the electric-power generating state, the control means controls the allowed maximum electric-power value to be greater than that set when no the regenerative electric-power generating unit is in the electric-power generating state. Accordingly, the air conditioning feeling is restricted from becoming worse while the generation of electric power insufficiency is prevented.

Preferably, the air conditioner further includes an increase determining means for determining whether the electric power actually consumed in the electric part is increased when the regeneration determination means determines that the regenerative electric-power generating unit is in the electric-power generating state. The air conditioner can includes an electric supply means for directly supplying electric power generated in the regenerative electric-power generating unit to the electric part without through a battery, at least when the regeneration determination means determines that the regenerative electric-power generating unit is in the electric-power generating state. Alternatively, the air conditioner includes an electric supply means for supplying electric power generated in the regenerative electric-power generating unit to the electric part through a battery mounted on the vehicle, and a battery changing detecting unit for detecting a remaining charging amount of the battery. In this case, the increase determining means determines whether the electric power actually consumed in the electric part is increased, when the remaining charging amount detected by the battery charging detecting unit is larger than a predetermined amount, in a case where the regeneration determination means determines that the regenerative electric-power generating unit is in the electric-power generating state. Accordingly, it can accurately prevent the electric power from being insufficient.

When the air conditioning unit has various kinds of the electric parts, the electric power increasing means increases the electric power actually consumed in the electric parts such that after the electric power increasing means increases the electric power actually consumed in one of the electric parts, the electric power increasing means increases the electric power actually consumed in an another one of the electric parts.

According to the present invention, the control means increases the allowed maximum electric-power value of the electric part, when an air blowing amount of a blower for blowing air into the passenger compartment is more than a predetermined amount in a case where the regeneration determination means determines that the regenerative electric-power generating unit is in the electric-power generating state. Alternatively, the control means increases the allowed maximum electric-power value of the electric part, when an outside air temperature detected by an outside temperature sensor is lower than a predetermined temperature in a heating operation for heating the passenger compartment, in a case where the regeneration determination means determines that the regenerative electric-power generating unit is in the electric-power generating state. Further, the control means increases the allowed maximum electric-power value of the electric part, when a temperature of the waste heat of the vehicle flowing into a heater core for heating the passenger compartment is lower than a predetermined temperature in the heating operation, in a case where the regeneration determination means determines that the regenerative electric-power generating unit is in the electric-power generating state.

Further, in the present invention, the control means increases the allowed maximum electric-power value of the electric part, when the outside air temperature detected by the outside temperature sensor is higher than a predetermined temperature in a cooling operation for cooling the passenger compartment, in a case where the regeneration determination means determines that the regenerative electric-power generating unit is in the electric-power generating state. Preferably, the control means increases the allowed maximum electric-power value of the electric part, when the solar radiation amount detected by the solar radiation detection sensor is larger than a predetermined amount in the cooling operation, in a case where the regeneration determination means determines that the regenerative electric-power generating unit is in the electric-power generating state.

### BRIEF DESCRIPTION OF THE DRAWINGS

Other objects, features and advantages of the present invention will become more apparent from the following detailed description made with reference to the accompanying drawings, in which:

FIG. 1 is a schematic diagram showing a vehicle air conditioner according to a first embodiment of the present invention;

FIG. 2 is a flow diagram showing a control operation of the air conditioner according to the first embodiment;

FIG. 3 is a schematic diagram showing a vehicle air conditioner according to a second embodiment of the present invention;

FIG. 4 is a flow diagram showing a control operation of the air conditioner according to the second embodiment;

FIG. 5 is a schematic diagram showing a vehicle air conditioner according to a third embodiment of the present invention;

FIG. 6 is a flow diagram showing a control operation of an air conditioner according to a fourth embodiment of the present invention;

FIG. 7 is a flow diagram showing a control operation of an air conditioner according to a fifth embodiment of the present invention; and

FIG. 8 is a flow diagram showing a control operation of an air conditioner according to a sixth embodiment of the present invention.

### DESCRIPTION OF THE PREFERRED EMBODIMENTS

(First Embodiment)

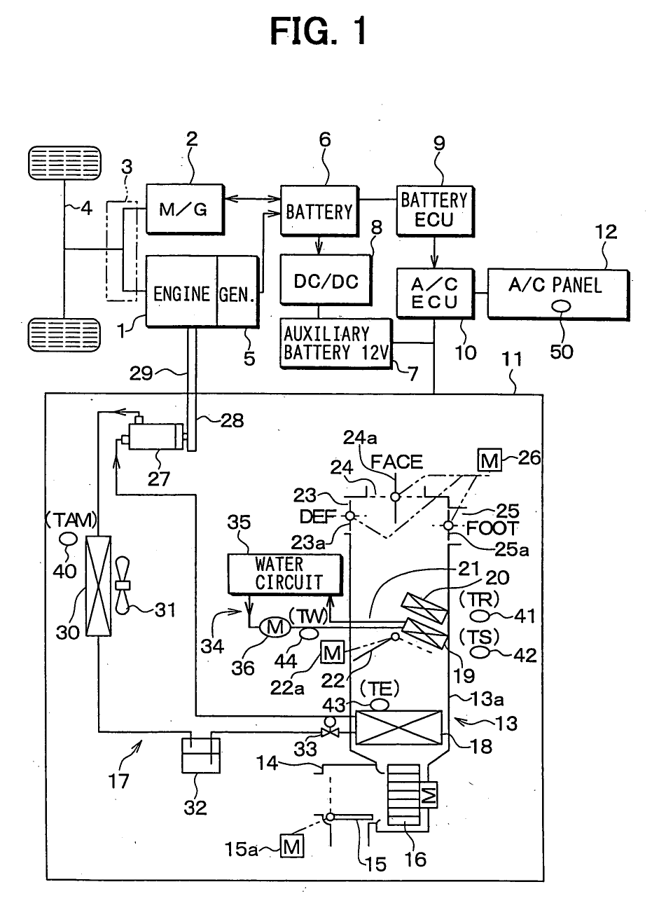

FIG. 1 is a view showing the construction of an entire system including an air conditioner for a vehicle in accordance with a first embodiment of the present invention. The first embodiment shows an example in which the present invention is applied to a hybrid vehicle. The hybrid vehicle has both an engine (internal combustion engine) 1 and an electric motor 2 as a driving source for running the vehicle.

The electric motor 2 in this embodiment is a motor generator also used as an electric generator. When electric power is supplied, the electric motor 2 functions as an electric motor. The electric motor 2 also functions as a regenerative electric-power generating unit in which mechanical energy from the driving wheel side, i.e., operating energy of the vehicle at the running time of the vehicle is regenerated as electric energy by a power switching mechanism 3.

The power switching mechanism 3 has a function for switching the transmission direction of power between the engine 1, the electric motor 2 and an axle 4 for the driving wheel. Concretely, it is possible to switch a state in which only the power of the engine 1 is transmitted to the axle 4, a state in which only the power of the electric motor 2 is transmitted to the axle 4, and a state in which both of the powers of the engine 1 and the electric motor 2 are transmitted to the axle 4.

An electric generator 5 for generating electricity by receiving the supply of the power from the engine 1 is connected to the output shaft of the engine 1. The electric power generated by this electric generator 5 and the electric power generated by the electric motor (motor generator) 2 are rectified and are then charged to a battery 6 constituting a secondary battery for running.

The battery 6 mainly supplies driving electric power to the electric motor 2. Therefore, its output voltage is a high voltage such as about 300 V. Therefore, an auxiliary battery 7 of low output voltage is mounted to the vehicle. This auxiliary battery 7 charges the electric power supplied from the battery 6 and reduced until a predetermined voltage (e.g., 12 V) by a transformer (DC-DC converter) 8. In this connection, the auxiliary battery 7 supplies the electric power to various vehicle auxiliary devices such as an electric device for air conditioning, etc. described later.

A battery controller (hereinafter called a battery ECU) 9 determines the remaining charging amount of the battery 6 and controls the operation of the engine 1 that is a driving source of the electric generator 5, etc., and manages the remaining charging amount of the battery 6. A determining method of the remaining charging amount of the battery 6 using the battery ECU 9 is as follows. Namely, it is possible to use a method for arranging a sensor for detecting a change in the specific gravity of an electrolyte of the battery 6. In this case, the remaining charging amount of the battery 6 is determined on the basis of a detecting signal of this specific gravity detecting sensor. Otherwise, it is possible to use a method for calculating (presuming) the remaining charging amount by integrating the respective electric current values of charging and discharging of the battery 6 and charging and discharging times of the battery 6 and the like.

An air conditioning controller (hereinafter called an air conditioning ECU) 10 controls the operations of various electric devices (actuator section) for air conditioning arranged in an air conditioner 11. An operating signal from each operating member on an air conditioning operation panel 12, sensor signals from sensor groups 40-44, an operation inhibiting signal from the battery ECU 9 and the like are inputted to the air conditioning ECU 10.

Each of the battery ECU 9 and the air conditioning ECU 10 is constructed by a microcomputer and its peripheral circuit. However, the battery ECU 9 and the air conditioning ECU 10 can be integrally constructed by one microcomputer.

Next, the construction of the air conditioner 11 will be explained. The construction of the air conditioner 11 is generally divided into three systems constructed of a ventilation system for a passenger compartment, a refrigerating cycle system and a water circuit system.

First, an indoor air-conditioning unit section 13 constituting the ventilation system for the passenger compartment will be described.

The indoor air-conditioning unit section 13 is arranged inside an instrument panel (dashboard) forward within the passenger compartment, and has an air conditioning casing 13a forming an air passage for guiding conditioned air into the passenger compartment.

An inside/outside air switching box 14 is arranged on the uppermost side of an air flow of the air conditioning casing 13a, and switches and introduces inside air (i.e., air inside the passenger compartment) and outside air (i.e., air outside the passenger compartment) by an inside/outside air switching door 15. This inside/outside air switching door 15 is operated by an actuator 15a such as a servo motor, etc.

Air introduced from the inside/outside air switching box 14 is blown by an electric indoor blower 16 of a centrifugal type toward the passenger compartment through the air passage within the air conditioning casing 13a. An evaporator 18 of a refrigerating cycle 17 is arranged downstream of the indoor blower 16, as a cooling heat exchanger for cooling the passenger compartment. A heater core 19 using cooling water of the engine 1 as a heat source is arranged as a heating heat exchanger for heating air, on a downstream side of this evaporator 18. An electric heater 20 is arranged as an auxiliary heating heat source, just after this heater core 19.

A bypass passage 21 through which air from the evaporator 18 bypasses the heater core 19 and the electric heater 20 is formed in the air conditioning case 13a on the sides of the heater core 19 and the electric heater 20. An air mix door 22 for adjusting a ratio of a cold air passing through this bypass passage 21 and a warm air passing through the heater core 19 is rotatably arranged upstream of the heater core 19. The air mix door 22 is a temperature adjusting unit for adjusting the temperature of the air blown into the passenger compartment by adjusting the blowing amount ratio of the cold air and warm air, and is operated by an actuator 22a such as a servo motor. The cold air from the bypass passage 21 and the warm air from the electric heater 21 (heater core 19) are mixed in accordance with the operation position of the actuator 22a, so that conditioned air is obtained.

A defroster opening portion 23 for blowing-out the conditioned air toward the inner surface of a front windshield of the vehicle, a face opening portion 24 for blowing-out the conditioned air toward the upper half of a passenger, and a foot opening portion 25 for blowing-out the conditioned air toward a foot portion of the passenger are formed on the most downstream side of the air flow of the air conditioning casing 13a.

Blowing-out modes such as well-known a face mode, a bi-level mode, a foot mode, a foot/defroster mode and a defroster mode are selected by controlling the opening and closing operations of these opening portions 23, 24, 25 by respective blowing-out mode doors 23a, 24a, 25a. The blowing-out mode doors 23a, 24a, 25a are operated by an actuator 26 such as a servo motor through a link mechanism and the like.

The refrigerating cycle 17 will next be explained.

A compressor 27 for compressing and discharging a refrigerant is operated by the engine 1 through an electromagnetic clutch 28, a belt 29 and the like. The high pressure gas refrigerant discharged from the compressor 27 exchanges heat with the outside air in a condenser 30, and is cooled and condensed. The outside air is blown by an electric outdoor blower 31 to the condenser 30.

The refrigerant condensed in the condenser 30 is separated into gas refrigerant and liquid refrigerant in a liquid receiver 32, and the liquid refrigerant is flowed out of the liquid receiver 32 onto the downstream side. This high pressure liquid refrigerant is decompressed and expanded by a pressure reduction device 33 such as a thermal type expansion valve, and becomes a gas-liquid two-phase state having a low pressure. This low pressure refrigerant exchanges heat with the air to be blown into the passenger compartment in the evaporator 18, and is evaporated, so that the air to be blown into the passenger compartment is cooled. The gas refrigerant evaporated in the evaporator 18 is sucked into the compressor 27, and is again compressed.

Next, the water circuit system will be now described. A warm water circuit 34 of the heater core 19 is coupled to a vehicle-side warm water circuit 35 including the engine 1. Hot water heated by this vehicle-side warm water circuit 35 is circulated in the heater core 19 by an electric water pump 36. Accordingly, the engine 1 is also used as a warm water heating source.

In this example, an outside air temperature sensor 40 for detecting an outside air temperature TAM, an inside air temperature sensor 41 for detecting an inside air temperature TR within the passenger compartment, a solar radiation sensor 42 for detecting a solar radiation amount TS entering into the passenger compartment, an evaporator blowing-out temperature sensor (evaporator cooling degree detecting means) 43 for detecting a blowing-out temperature TE of the evaporator 18, a water temperature sensor 44 for detecting a water temperature TW circuited in the heater core 19 and the like are provided as a sensor group for an automatic control of the air conditioning.

As is well-known, the air conditioning operation panel 12 has operating members such as an air conditioning switch for giving commands for starting and stopping the operation of the refrigerating cycle 17 (compressor 27), an inside/outside air change-over switch for switching an inside/outside air sucking mode of the inside/outside air switching box 14, a temperature setting switch for setting the temperature within the passenger compartment to a predetermined desirable temperature, a blowing amount change-over switch for switching the air blowing amount of the blower 16, and a blowing-out mode change-over switch for switching a blowing-out mode, etc.

A display device 50 for displaying information such as an air conditioning operating limit period, etc. is also arranged in the air conditioning operation panel 12. This display device 50 can be constructed by a light emitting diode that is lighted during the air conditioning operating limit period, etc.

The air conditioning unit 13 is arranged for a front seat in the passenger compartment. In this embodiment, a rear air conditioning unit (not shown) for a rear seat is also arranged in addition to the air conditioning unit for the front seat. Thus, the conditioned air adjusted in temperature by the rear air conditioning unit is blown to a space within the passenger compartment on the rear seat side. In this connection, a blower, an evaporator, a heater core, etc. are also equipped in the rear air conditioning unit for the rear seat. Hear, the blower, a door actuator and the like of the rear air conditioner are equipped as electric devices.

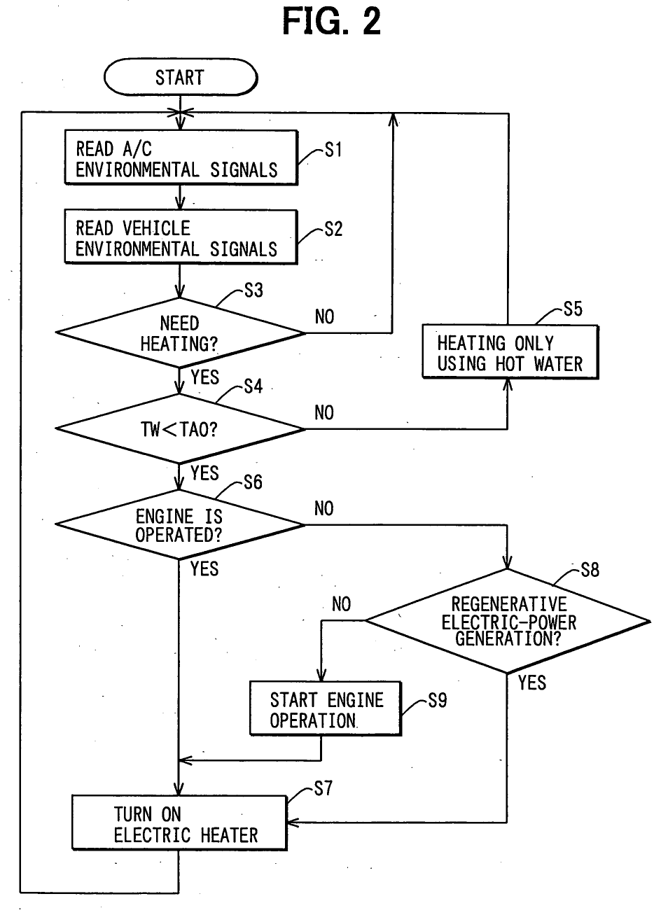

The control of the electric heater 20 as an electric part of the air conditioner, i.e., the control operation of the air conditioning ECU 10 will next be described with reference to FIG. 2.

As shown in FIG. 2, first, the signals of a sensor group for the automatic control of the air conditioning, i.e., the signals of a sensor group showing an air conditioning environmental state, and a vehicle environmental state such as a vehicle speed, engine cooling water, etc. are read at steps S1, S2. Then, it is also determined whether or not it is necessary to perform a heating operation for heating the passenger compartment at step S3. When it is not necessary to perform the heating operation, it is returned to step S1.

The determination as to whether or not it is necessary to perform the heating operation in this embodiment is performed by determining whether or not a target blowing-out temperature TAO calculated on the basis of a signal value of the sensor group showing the air conditioning environmental state is a predetermined value or more. The target blowing-out temperature TAO is a target temperature of air to be blown into the passenger compartment.

When it is necessary to perform the heating operation, it is determined whether the temperature Tw of the engine cooling water is lower than the target blowing-out temperature TAO or not at step S4. When the temperature Tw of the engine cooling water is equal to or higher than the target blowing-out temperature TAO, the air blown into the passenger compartment can be sufficiently heated by only using the heater core 19. Namely, it is considered that the interior of the passenger compartment can be heated without supplying electricity to the electric heater 20, and the heating operation is performed by using only the engine cooling water at step S5.

In contrast to this, when the temperature Tw of the engine cooling water is lower than the target blowing-out temperature TAO, air to be blown into the passenger compartment cannot be sufficiently heated by only using the heater core 19, and it is considered that it is necessary to supply electricity to the electric heater 20. It is then determined whether the engine 1 is operated or not, i.e., whether electricity is generated in the electric generator 5 or not at step S6.

When the engine 1 is operated, it is considered that no electric power insufficiency is generated even when electricity is supplied the electric heater 20, and electricity is turned on in the electric heater 20 at step S7.

Further, when the operation of the engine 1 is stopped, it is determined whether regenerative electric power generation is performed in the electric motor 2 or not at step S8. When the regenerative electric power generation is performed in the electric motor 2, it is considered that no electric power insufficiency is generated even when electricity is turned on in the electric heater 20, and electricity is turned on in the electric heater 20 at step S7.

In contrast to this, when no regenerative electric power generation is performed in the electric motor 2, the request that the engine 1 is started is sent to the battery ECU 9. In this case, after the engine 1 is started at step S9, electricity is turned on in the electric heater 20 at step S7.

The regenerative electric power generation is performed by the electric motor 2 at a braking time or when the operating amount of a driving force control means for controlling the running driving force of an accelerator pedal, etc. is reduced and a so-called engine brake is operated.

The operation and effect of this embodiment will next be described.

In this embodiment, it is determined whether the regenerative electric power generation is performed in the electric motor 2 or not. When the regenerative electric power generation is performed in the electric motor 2, electricity is supplied to the electric heater 20. Namely, when it is determined that the electric motor 2 is in an electric power generating state, it is allowed that electricity is turned on in the electric heater 20. Accordingly, an allowed maximum electric power value of the power consumption amount in the air conditioner is set to be greater than the allowed maximum electric-power value set when it is determined that no electric motor 2 is in the electric power generating state. Thus, it is possible to restrain the air conditioning feeling from becoming worse while preventing the electric power supplied to the electric motor 2 from being insufficient by consuming the electric power of the battery 6 by the air conditioner (electric heater 20 in this case).

Further, electricity is turned on in the electric heater 20 when the regenerative electric power generation is performed. Accordingly, the generation of the problem that the electric power supplied to the electric heater 20 is insufficient can be prevented in advance. Further, the electricity supply amount to the electric heater 20 can be increased.

Further, when the regenerative electric power generation is performed in the electric motor 2, the remaining electric power amount of the battery 6 is detected. When the remaining electric power amount of the battery 6 is a predetermined value or more and the electric power amount actually consumed in the electric heater 20 is increased, it is possible to more reliably restrain the air conditioning feeling from becoming worse while preventing the electric power supplied to the electric motor 2 from being insufficient.

(Second Embodiment)

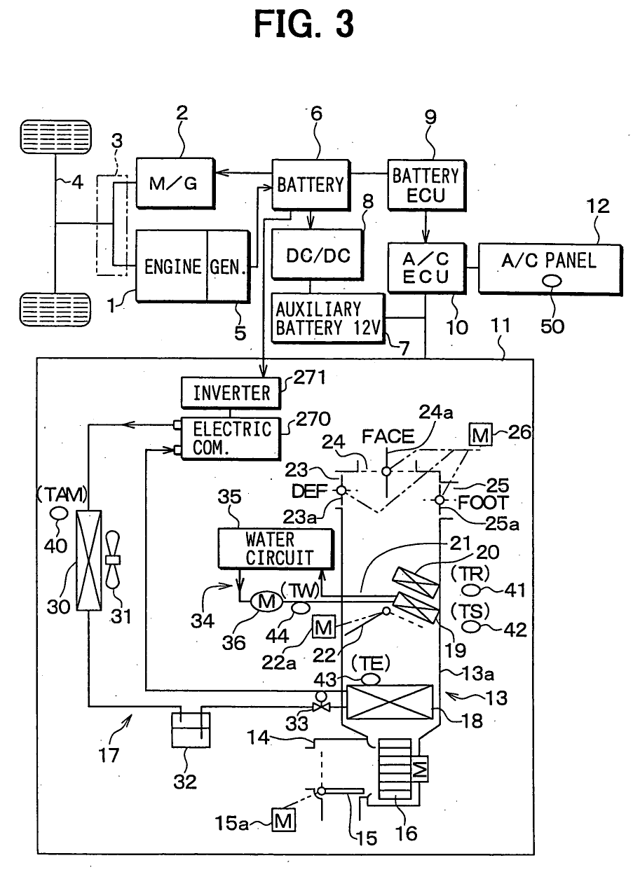

In the above-described first embodiment, the compressor 27 is belt-operated by the engine 1, and its control is performed by ON-OFF control of the electromagnetic clutch 28. However, in the second embodiment, an electric compressor 270 is integrated with the electric motor for operating the compressor 27 is used as shown in FIG. 3. A rotation number control (rotation speed control) of the compressor 27 is performed by converting direct current electric power supplied from the battery 6 to a three-phase alternating current having a predetermined frequency by an inverter 271.

Next, the control of the electric compressor 270 among the control operation of the air conditioning ECU 10 will be now described. The rotation number (rotation speed) of the electric compressor 270 is controlled so that the air temperature just after passing through the evaporator 18 becomes a target value (i.e., target post-evaporator temperature TEO). Concretely, in this embodiment, one of a full mode and an economy mode is selected. In the full mode, the target post-evaporator temperature TEO is set to about 3° C. to 4° C., and the air is cooled while the generation of frost is prevented. In the economy mode, the target post-evaporator temperature TEO is set to 10° C. to 12° C., or is set to the same temperature as the target blowing-out temperature TAO.

Since the target post-evaporator temperature TEO is low in the full mode in comparison with that in the economy mode, power consumption in the electric compressor 270 is increased in the full mode in comparison with that in the economy.

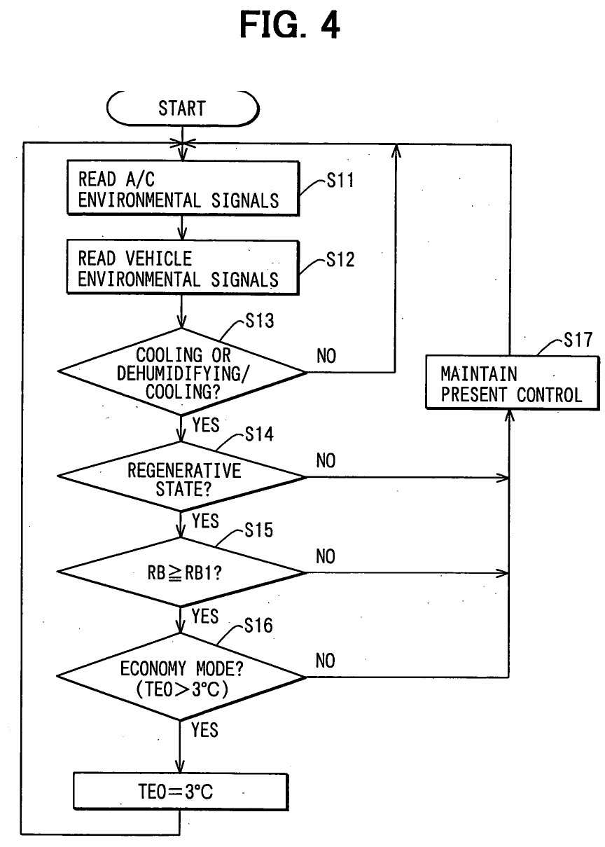

The characteristic operation of this second embodiment will next be described on the basis of the flow chart shown in FIG. 4.

First, as shown in FIG. 4, the signals of a sensor group showing an air conditioning environmental state and a vehicle environmental state such as a vehicle speed, engine cooling water, etc. are read at steps S11, S12. Then, it is determined whether it is necessary to perform the cooling operation or a dehumidifying/cooling operation or not at step S13. When it is not necessary to perform the cooling operation for cooling the passenger compartment or the dehumidifying/cooling operation for cooling and dehumidifying the passenger compartment, it is returned to step S11.

The determination as to whether or not it is necessary to perform the cooling operation or the dehumidifying/cooling operation in this embodiment is performed by determining whether or not the target blowing-out temperature TAO is equal to or lower than a predetermined value.

It is determined whether the regenerative electric power generation is performed in the electric motor 2 or not at step S14. When the regenerative electric power generation is performed in the electric motor 2, the remaining electric power amount of the battery 6 is detected and it is determined whether or not the remaining electric power amount RB is a predetermined value RB1 or more at step S15. When the remaining electric power amount RB is the predetermined value RB or more, it is determined whether it is in the economy mode or in the full mode time at step S16.

Generally, when it is the economy mode can be determined when the target post-evaporator air temperature TEO is higher than a predetermined value (e.g., 3° C.). When the economy mode is determined at step S16, the control mode is changed to the full mode control from the economy mode. That is, when the economy mode is determined at step S16, the target post-evaporator temperature TEO is set at 3° C. In this case, the full mode can be switched from the economy mode. On the other hand, when the determination at steps S14 to S16 is NO, the present control is maintained and performed at step S17. Namely, the economy mode control is performed when the economy mode is set, and the full mode control is performed when the full mode is set, at step S17.

The operation and effect of this second embodiment will next be described.

When it is determined that the electric motor 2 is in an electric power generating state, it can proceed to the full mode from the economy mode. Accordingly, the allowed maximum electric power value of the power consumption amount in the air conditioner is permitted to be greater than the allowed maximum electric power value set when it is determined that no electric motor 2 is in the electric power generating state.

Accordingly, it is possible to prevent the air conditioning feeling from becoming worse while restricting the electric power supplied to the electric motor 2 from being insufficient due to consumption of the electric power of the battery 6 by the air conditioner (i.e., electric compressor 270, in this case).

Further, since it can proceed to the full mode when the regenerative electric-power generation is performed, the generation of the problem that the electric power supplied to the electric compressor 270 is insufficient can be prevented in advance. Further, the control operation can be changed from the economy mode control to the full mode control.

When the regenerative electric-power generation is performed in the electric motor 2, the remaining electric power amount (RB) of the battery 6 is detected and the electric power amount actually consumed in the electric compressor 270 is increased when the remaining electric power amount (RB) is a predetermined value (LB1) or more. Accordingly, it is possible to more reliably restrict the air conditioning feeling from becoming worse while preventing the electric power supplied to the electric motor 2 from being insufficient.

(Third Embodiment)

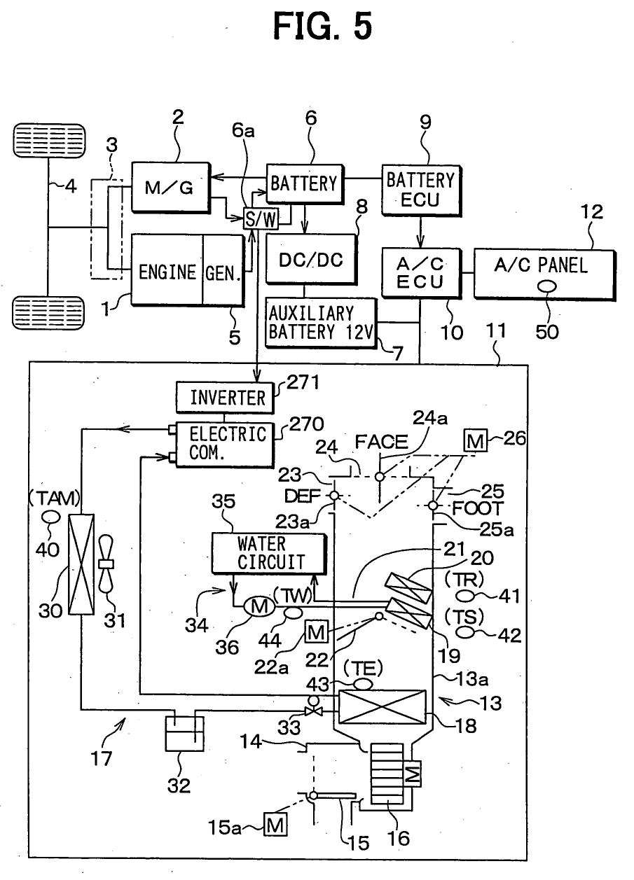

As shown in FIG. 5, in this third embodiment, there is provided with an electric current switching device 6a for supplying the electric power generated in the electric motor 2 to the electric compressor 270 as an electric part of the air conditioner without through the battery 6 when it is determined that the electric motor 2 is in the electric power generating state. In the third embodiment, the other parts are similar to those of the above-described second embodiment.

(Fourth Embodiment)

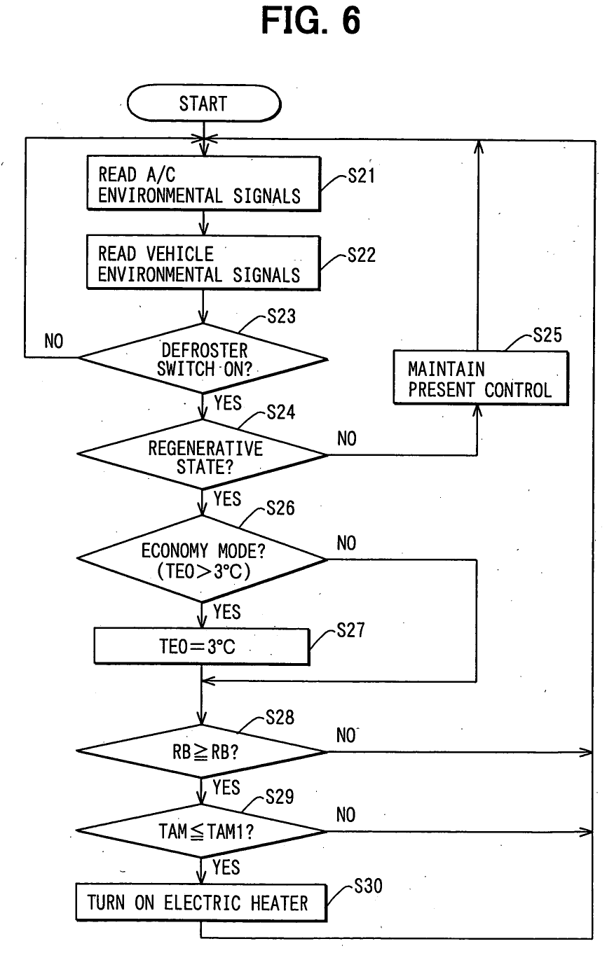

This embodiment relates to control in performing a dehumidifying and heating operation. In the dehumidifying and heating operation, when the regenerative electric power generation is performed, the insufficiency of electric power supplied to the electric motor 2 is prevented while securing defrosting performance, by supplying electricity to the electric heater 20 if necessary after the allowed maximum electric power in the electric compressor 270 is increased. A concrete control flow of this embodiment will next be described on the basis of FIG. 6.

The signals of a sensor group showing an air conditioning environmental state, and a vehicle environmental state such as a vehicle speed, engine cooling water, etc. are read at steps S21, S22. It is then determined whether a defroster switch is turned on or not at step S23. The defroster switch is a manual switch for blowing-out the conditioned air (particularly, air cooled by the evaporator 18) blown of the air conditioner to the windshield.

When the defroster switch is turned on at step S23, it is determined whether the regenerative electric power generation is performed in the electric motor 2 or not at step S24. When no regenerative electric power generation is performed at step S24, the control of the electric compressor 270 is set as it is. Namely, the economy mode control is performed when the economy mode is set, and the full mode control is performed when the full mode is set. In this state, the blowing-out mode is set to a defroster mode at step S25.

In contrast to this, when the regenerative electric power generation is performed, it is determined whether it is in the economy mode control or not at step S26. That is, it is determined whether or not the target post-evaporator air temperature TEO is larger than 3° C. at step S26. When the target post-evaporator air temperature TEO is larger than 3° C., it is determined that the economy mode is performed. When it is in the economy mode control, the control mode is changed to the full mode control from the economy mode at step S27.

Next, the remaining electric power amount RB of the battery 6 is detected, and it is determined whether or not the remaining electric power amount RB is a predetermined value RB2 or more at step S28. When the remaining electric power amount RB is the predetermined value LB2 or more, it is determined whether or not the outside air temperature TAM is a predetermined temperature TAM1 or less at step S29. When the outside air temperature TAM is the predetermined temperature TAM1 or less, electricity is turned on in the electric heater 20 in a state in which the blowing-out mode is set to the defroster mode (S30).

When the determination at steps S28 and S29 is NO, only the control of the electric compressor 270 is performed and control program is returned to step S21.

(Fifth Embodiment)

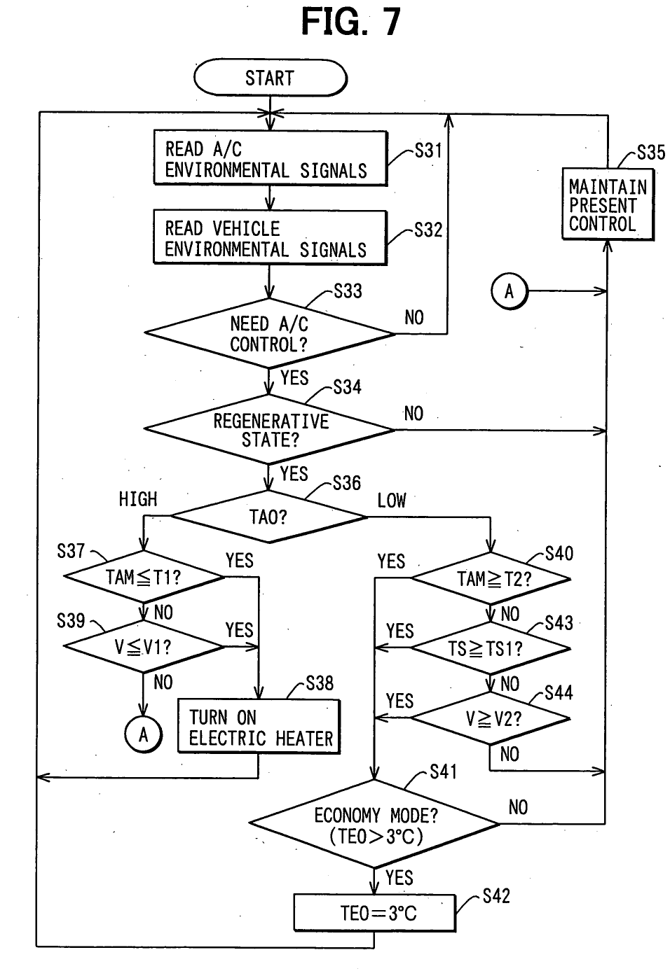

The fifth embodiment relates to control in the cooling operation and the dehumidifying and heating operation. In the fifth embodiment, when the regenerative electric-power generation is performed, the insufficiency of electric power supplied to the electric motor 2 is prevented while increasing the capability of the air conditioner by increasing the allowed maximum electric power in the electric compressor 270 or by supplying electricity to the electric heater 20 if necessary. A concrete control flow of this embodiment will next be described on the basis of FIG. 7.

The signals of a sensor group showing an air conditioning environmental state and a vehicle environmental state such as a vehicle speed, engine cooling water, etc. are read at S31, S32. Further, it is determined whether the air conditioner is operated or not by determining whether an A/C switch (a starting switch of the compressor) and an automatic control switch are turned on or not at step S33. That is, at step S33, it is determined whether or not air conditioning control (A/C control) is required.

When the air conditioner is operated at step S33, it is determined whether the regenerative electric power generation is performed in the electric motor 2 or not at step S34. When regenerative electric power generation is not performed at step S34, the control of the electric compressor 270 is set as it is. Namely, the control is performed in a state in which the economy mode control is performed when the economy mode is set, and the full mode control is performed when the full mode is set at step S35.

When the regenerative electric power generation is performed at step S34, it is determined which of the cooling operation and the dehumidifying and heating operation is performed, or which of the cooling operation and the dehumidifying and heating operation is performed on the basis of the target blowing-out temperature TAO, at step S36.

The cooling operation is normally performed when the target blowing-out temperature TAO is low. The dehumidifying and heating operation is normally performed when the target blowing-out temperature TAO is high. The target blowing-out temperature TAO constituting a threshold value for determining which of these operations is performed is differently set in a case of a raising process of the target blowing-out temperature TAO and a case of a lowering process of the target blowing-out temperature TAO.

When the dehumidifying and heating operation is performed, it is determined whether or not the outside air temperature TAM is a predetermined temperature T1 or less at step S37. When the outside air temperature TAM is the predetermined temperature T1 or less, it is considered that air to be blown into the passenger compartment cannot be sufficiently heated by only using the heater core 19, and electricity is turned on in the electric heater 20 at step S38.

In contrast to this, when the outside air temperature TAM is higher than the predetermined temperature T1 at step S37, it is determined whether or not the blowing amount V is a predetermined blowing amount V1 or more at step S39. When the blowing amount V is the predetermined blowing amount V1 or more, it is considered that the air conditioning load is large and air to be blown into the passenger compartment cannot be sufficiently heated by only using the heater core 19, and electricity is turned on in the electric heater 20 at step S38.

In contrast to this, when the cooling operation is performed, it is determined whether or not the outside air temperature TAM is a predetermined temperature T2 or more, at step S40. When the outside air temperature TAM is the predetermined temperature T2 or more, it is considered that the air conditioning load is large and there is a fear that the cooling capability of the evaporator 18 is insufficient. In this case, it is determined whether it is in the economy mode or in the full mode at step S41. For example, when the target post-evaporator air temperature TEO is larger than 3° C., it is determined that the economy mode is set at step S41.

When the economy mode is determined at step S41, the target post-evaporator air temperature TEO is set at 3° C., so that the control mode is changed from the economy mode to the full mode at step S42. When the full mode control is already performed, the present control, i.e., the full mode control is performed at step S35.

In contrast to this, when the outside air temperature TAM is less than the predetermined temperature T2, it is determined whether or not the solar radiation amount TS irradiated into the passenger compartment is a predetermined solar radiation amount TS1 or more at step S43. When the solar radiation amount TS is the predetermined solar radiation amount TS1 or more, it is considered that the air conditioning load is large and there is a fear that the cooling capability of the evaporator 18 is insufficient. In this case, it is determined whether it is on the economy mode or in the full mode at step S41. When it is in the economy mode, the full mode control is performed at step S42. When the full mode control is already performed, the present control, i.e., the full mode control is performed at step S35.

When the solar radiation amount TS is less than the predetermined solar radiation amount TS1, it is determined whether or not the blowing amount V is a predetermined blowing amount V2 or more at step S44. When the blowing amount V is the predetermined blowing amount V2 or more, it is considered that the air conditioning load is large and there is a fear that the cooling capability of the evaporator 18 is insufficient. In this case, it is determined whether it is in the economy mode or in the full mode at step S41. When it is in the economy mode, it proceeds to the full mode control at step S42. When the full mode control is already performed, the present control, i.e., the full mode control is performed at step S35.

(Sixth Embodiment)

In this sixth embodiment, the present invention is applied to a battery cooling device for cooling the battery 6. In the battery cooling device in this embodiment, the air within the passenger compartment is sucked and is blown to the battery 6. An electronic controller for controlling the battery cooling device is integrated with the air conditioning ECU 10.

In this sixth embodiment, when the regenerative electric power generation is performed, the allowed maximum electric power required to cool the battery 6 is increased if necessary.

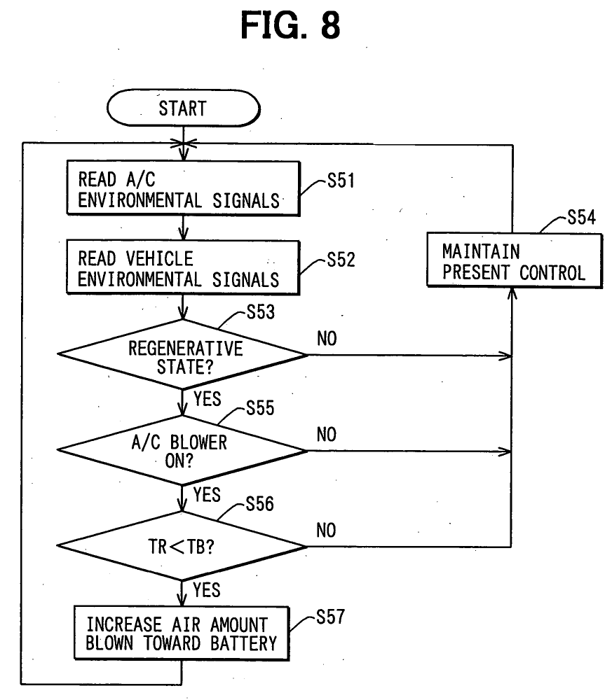

The characteristic operation of this embodiment will next be described on the basis of FIG. 8.

The signals of a sensor group showing an air conditioning environmental state, and a vehicle environmental state such as a vehicle speed, engine cooling water, etc. are read at steps S51, S52. It is then determined whether the regenerative electric power generation is performed in the electric motor 2 or not at step S53.

When no regenerative electric power generation is performed, the control of the electric compressor 270 is set as it is. Namely, the economy mode control is performed when the economy mode is set, and the full mode control is performed when the full mode control is set at step S54.

In contrast to this, when the regenerative electric power generation is performed at step S53, it is determined whether the indoor blower 16 of the air conditioner is operated or not at step S55. When the indoor blower 16 is operated, it is determined whether the inside air temperature TR is lower than the temperature TB of the battery 6 or not at step S56. When the inside air temperature TR is lower than the temperature TB of the battery 6, it is determined whether it is necessary to cool the battery 6 or not. Namely, it is determined whether or not the temperature of the battery 6 is a predetermined temperature or more. When the temperature of the battery 6 is the predetermined temperature or more, the air blowing amount of the blower for blowing cooling air to the battery 6 is increased at step S57.

When the determination at steps S53, S55, S56 is NO, the control of the electric compressor 270 is set as it is, at step S54.

Although the present invention has been fully described in connection with the preferred embodiments thereof with reference to the accompanying drawings, it is to be noted that various changes and modifications will become apparent to those skilled in the art.

For example, the air conditioner of the present invention can be suitably used for a hybrid vehicle having an engine and an electric motor as the driving source. Further, the present invention can be used for an electric device having the electrical parts (20, 270) mounted on the vehicle, without being limited to the air conditioning unit.

In the above-described sixth embodiment of the present invention, the electronic controller for the battery cooling device is integrated with the air conditioning ECU 10. However, the electronic controller for the battery cooling device can be separated from the air conditioning ECU 10, or can be constructed with the other structure.

Further, any two embodiments among the above-described first to sixth embodiments of the present invention can be suitably combined.

Such changes and modifications are to be understood as being within the scope of the present invention as defined by the appended claims.

What is claimed is:

1. An air conditioner for a vehicle having a regenerative electric-power generating unit for regenerating kinetic energy accumulated in the vehicle as electric energy by operating a driving source, the air conditioner comprising:
an air conditioning unit for performing air-conditioning operation of a passenger compartment of the vehicle, the air conditioning unit having an electric part that is operated by electrical power;
a regeneration determining means for determining whether the regenerative electric-power generating unit is in an electric-power generating state; and
a control means for controlling an allowed maximum electric-power value to be consumed in the electric part, wherein,
when the regeneration determination means determines that the regenerative electric-power generating unit is in the electric-power generating state, the control means controls the allowed maximum electric-power value to be greater than that set when no the regenerative electric-power generating unit is in the electric-power generating state.

2. The air conditioner according to claim 1, further comprising
increase determining means for determining whether the electric power actually consumed in the electric part is increased when the regeneration determination means determines that the regenerative electric-power generating unit is in the electric-power generating state.

3. The air conditioner according to claim 1, further comprising
an electric supply means for directly supplying electric power generated in the regenerative electric-power generating unit to the electric part without through a battery, at least when the regeneration determination means determines that the regenerative electric-power generating unit is in the electric-power generating state.

4. The air conditioner according to claim 1, further comprising
an electric supply means for supplying electric power generated in the regenerative electric-power generating unit to the electric part through a battery mounted on the vehicle;
a battery changing detecting unit for detecting a remaining charging amount of the battery; and
increase determining means for determining whether the electric power actually consumed in the electric part is increased, when the remaining charging amount detected by the battery charging detecting unit is larger than a predetermined amount, in a case where the regeneration determination means determines that the regenerative electric-power generating unit is in the electric-power generating state.

5. The air conditioner according to claim 2, wherein the air conditioning unit has various kinds of the electric parts, the air conditioner further comprising
electric power increasing means for increasing the electric power actually consumed in the electric parts, wherein after the electric power increasing means increases the electric power actually consumed in one of the electric parts, the electric power increasing means increases the electric power actually consumed in an another one of the electric parts.

6. The air conditioner according to claim 1, wherein:
the air conditioning unit includes a blower for blowing air into the passenger compartment; and
the control means increases the allowed maximum electric-power value of the electric part, when an air blowing amount of the blower is more than a predetermined amount in a case where the regeneration determination means determines that the regenerative electric-power generating unit is in the electric-power generating state.

7. The air conditioner according to claim 1, further comprising
an outside temperature sensor for detecting an outside air temperature outside the passenger compartment, wherein,
the control means increases the allowed maximum electric-power value of the electric part, when the outside air temperature detected by the outside temperature sensor is lower than a predetermined temperature in a heating operation for heating the passenger compartment, in a case where the regeneration determination means determines that the regenerative electric-power generating unit is in the electric-power generating state.

8. The air conditioner according to claim 1, wherein:
the air conditioning unit includes a heater core for heating air to be blown into the passenger compartment by using waste heat from the vehicle as a heating source; and
the control means increases the allowed maximum electric-power value of the electric part, when a temperature of the waste heat is lower than a predetermined temperature in a heating operation for heating the passenger compartment, in a case where the regeneration determination means determines that the regenerative electric-power generating unit is in the electric-power generating state.

9. The air conditioner according to claim 1, further comprising
an outside temperature sensor for detecting an outside air temperature outside the passenger compartment, wherein,
the control means increases the allowed maximum electric-power value of the electric part, when the outside air temperature detected by the outside temperature sensor is higher than a predetermined temperature in a cooling operation for cooling the passenger compartment, in a case where the regeneration determination means determines that the regenerative electric-power generating unit is in the electric-power generating state.

10. The air conditioner according to claim 1, further comprising
a solar radiation detection sensor for detecting a solar radiation amount entering the passenger compartment, wherein,
the control means increases the allowed maximum electric-power value of the electric part, when the solar radiation amount detected by the solar radiation detection sensor is larger than a predetermined amount in a cooling operation for cooling the passenger compartment, in a case where the regeneration determination means determines that the regenerative electric-power generating unit is in the electric-power generating state.

11. The air conditioner according to claim 1, wherein the vehicle is a hybrid vehicle having an engine and an electric motor as the driving source.

12. An electric device for a vehicle having a regenerative electric-power generating unit for regenerating kinetic energy accumulated in the vehicle as electric energy by operating a driving source, the electric device comprising:
an electric part that is operated by electrical power;
a regeneration determining means for determining whether the regenerative electric-power generating unit is in an electric-power generating state; and
a control means for controlling an allowed maximum electric-power value to be consumed in the electric part, wherein,
when the regeneration determination means determines that the regenerative electric-power generating unit is in the electric-power generating state, the control means controls the allowed maximum electric-power value to be greater than that set when no the regenerative electric-power generating unit is in the electric-power generating state.

13. The electric device according to claim 12, further comprising
increase determining means for determining whether the electric power actually consumed in the electric part is increased when the regeneration determination means determines that the regenerative electric-power generating unit is in the electric-power generating state.

14. The electric device according to claim 12, further comprising
an electric supply means for directly supplying electric power generated in the regenerative electric-power generating unit to the electric part without through a battery, at least when the regeneration determination means determines that the regenerative electric-power generating unit is in the electric-power generating state.

15. The electric device according to claim 12, further comprising
an electric supply means for supplying electric power generated in the regenerative electric-power generating unit to the electric part through a battery mounted on the vehicle;
a battery changing detecting unit for detecting a remaining charging amount of the battery; and
increase determining means for determining whether the electric power actually consumed in the electric part is increased, when the remaining charging amount detected by the battery charging detecting unit is larger than a predetermined amount, in a case where the regeneration determination means determines that the regenerative electric-power generating unit is in the electric-power generating state.

16. The electric device according to claim 13, wherein the air conditioning unit has a various kinds of the electric parts, the air conditioner further comprising
electric power increasing means for increasing the electric power actually consumed in the electric parts, wherein after the electric power increasing means increases the electric power actually consumed in one of the electric parts, the electric power increasing means increases the electric power actually consumed in an another one of the electric parts.

17. The electric device according to claim 12, wherein the vehicle is a hybrid vehicle having an engine and an electric motor as the driving source.
